(19) United States
(12) Patent Application Publication
(10) Pub. No.: US 2005/0237491 A1
(43) Pub. Date: Oct. 27, 2005

(54) Optical projection module and fan assembly thereof

(75) Inventors: Kuo-Cheng Lin, Taoyuan Hsien (TW); Ke-Nan Wang, Taoyuan Hsien (TW); Wen-Shi Huang, Taoyuan Hsien (TW)

Correspondence Address: BIRCH STEWART KOLASCH & BIRCH, PO BOX 747, FALLS CHURCH, VA, 22040-0747, US

(73) Assignee: Delta Electronics, Inc.

(21) Appl. No.: 11/111,718

(22) Filed: Apr. 22, 2005

(30) Foreign Application Priority Data
Apr. 23, 2004 (TW) 93111409

(51) Int. Cl. G03B 21/18

(52) U.S. Cl. 353/57

(57) ABSTRACT

An optical projection module and a fan assembly thereof. A casing comprises at least one heat-dissipation vent. An image projection module is disposed in the casing to create an image. A light source provides light to the image projection module. A fan disposed in the heat-dissipation vent comprises a hub and a plurality of primary blades encircling the hub. Adjacent primary blades overlap in an axial direction. A region formed by the primary blades and the hub blocks a light from transmitting through the heat-dissipation vent.

### BACKGROUND

The invention relates to an optical projection module, and in particular to an optical projection module and fan assembly thereof.

An image projection apparatus or overhead projector comprises a light bulb and an optical engine. During operation, temperature is significantly increased due to heat produced from the light bulb and the optical engine. High temperature may damage the coating on the optical engine such that optical performance deteriorates, and lifetime of the light bulb and the optical engine may be reduced accordingly. Thus, an efficient heat dissipation system is required.

In a conventional projector, a casing with a heat-dissipation vent is disposed near a light bulb. An axial fan is disposed on the heat-dissipation vent to dissipate heat from the projector.

Since blades of the conventional fan are arranged in a frame, a gap exists between the blades and the frame through which light is easily lost, reducing projector performance.

Thus, an improved design is disclosed in Japan patent NO. 11167166. A light blocking structure is disposed at the heat-dissipation vent on a side of the casing to reduce light loss.

Although the light blocking structure blocks the light, heat dissipation may be adversely blocked, reducing efficiency thereof.

### SUMMARY

Embodiments of the invention provide an optical projection module comprising a casing, an image projection module, a light source, and at least one fan. The casing comprises at least one heat-dissipation vent. The image projection module and the light source are disposed in the casing, providing an image. The fan disposed in the heat-dissipation vent of the casing comprises a hub and a plurality of primary blades encircling the hub. The adjacent primary blades partially overlap in an axial direction without direct contact therebetween. A region formed by the primary blades and the hub blocks the light transmitting through the heat-dissipation vent. Light produced from the light source is completely blocked by the fan.

Embodiments of the invention further provide a fan assembly applicable in an optical projection module with a light source and a casing. The casing comprises at least one heat-dissipation vent. The fan assembly comprises a hub and a plurality of primary blades. The primary blades encircle the hub. The adjacent primary blades partially overlap in an axial direction without direct contact therebetween. A region formed by the primary blades and the hub blocks the light transmitting through the heat-dissipation vent such that light from the light source is completely blocked.

In an optical projection module and a fan assembly according to embodiments of the invention, the hub of the fan assembly comprises a plurality of bodies. A plurality of secondary blades encircle each body of the hub. The secondary blades on the body correspond to each other, combined to form primary blades, and comprise connecting portions corresponding to each other.

Furthermore, each secondary blade has a similar shape and dimension to each primary blade, and are alternatively or correspondingly arranged to constitute the primary blades. The bodies comprise connecting portions having corresponding connecting shapes.

The primary or secondary blades are flat, wing-shaped, curved, or sloped. The shape can be different from or substantially correspond to the shape of the heat-dissipation vent.

The optical projection module further comprises a base. The fan is disposed on the casing via the base. The base and the fan are connected by engaging, locking, gluing, or combination thereof.

The optical projection module further comprises at least one guide structure, encircling the heat-dissipation vent on the casing or encircling a periphery of the fan on the casing. The casing and the guide structure are connected by engaging, locking, gluing, or combination thereof, and can be integrally formed into one unit. The guide structure comprises guide walls with a predetermined gap therebetween.

Moreover, the hub may further comprise at least one opening defined thereon. The opening can be polygonal, circular, or elliptical. The fan assembly comprises a light blocking fan, a fan without a frame or a fan with a frame.

The fan assembly can be disposed in the front or back of the optical projection module, providing sufficient heat dissipation.

### BRIEF DESCRIPTION OF THE DRAWINGS

Embodiments of the invention can be more fully understood by reading the subsequent detailed description in conjunction with the examples and references made to the accompanying drawings, wherein:

FIG. 1 is a schematic front view of an optical projection module of embodiments of the invention;

FIG. 2 is a side view of the optical projection module of FIG. 1;

FIG. 3 is a top view of the optical projection module of FIG. 1;

FIG. 4A is a schematic diagram of a fan assembly of a first embodiment of the invention;

FIG. 4B is a top view of the fan assembly of FIG. 4A;

FIG. 4C is a perspective side view of the fan assembly of FIG. 4A;

FIG. 5A is a schematic diagram of a fan assembly of a second embodiment of the invention;

FIG. 5B is an exploded view of the fan assembly of FIG. 5A;

FIG. 5C is an exploded view of a variation of the fan assembly of FIG. 5A;

FIG. 6A is a schematic diagram of a fan assembly of a third embodiment of the invention;

FIG. 6B is an exploded view of the fan assembly of FIG. 6A;

FIG. 7A is a schematic diagram of a fan assembly of a fourth embodiment of the invention; and

FIG. 7B is an exploded view of the fan assembly of FIG. 7A.

### DETAILED DESCRIPTION

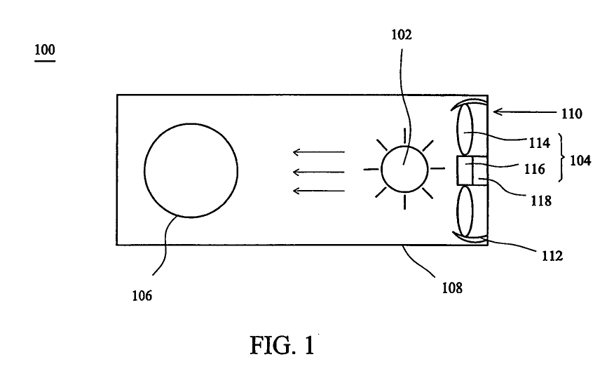

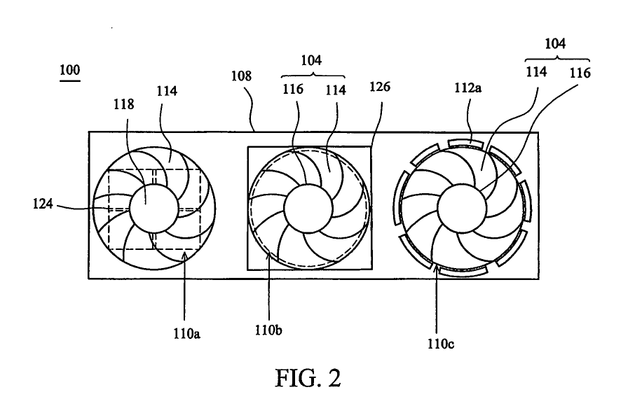

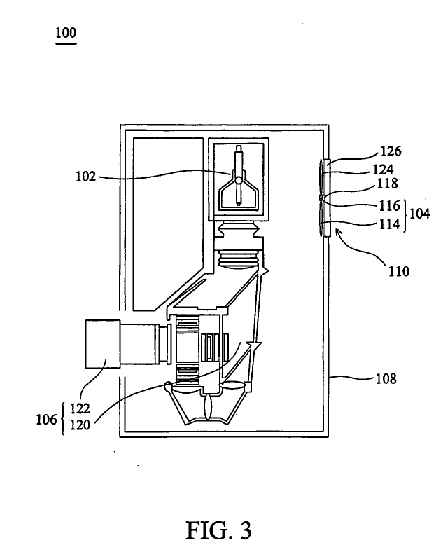

FIG. 1 is a schematic front view of an optical projection module 100 of embodiments of the invention. FIG. 2 is a side view of the optical projection module 100 of FIG. 1. FIG. 3 is a top view of the optical projection module 100 of FIG. 1. In FIG. 2, while three different shapes of heat-dissipation vents are shown, embodiments of the invention are not limited to the combinations shown. The invention may utilize one fan assembly and one heat-dissipation vent. In the following embodiments, the number and types of fan assembly and heat-dissipation vents can vary with practical requirements.

As shown in FIGS. 1-3, the optical projection module 100 comprises a light source 102, a light-blocking fan assembly 104, an image projection module 106, and a casing 108. The fan assembly 104 comprises a fan without a frame or a fan with a frame. The optical projection module 100 can comprise a projector or other image processing apparatus.

The light source 102 provides light for the optical projection module 100, and comprises a point light, linear light, planar light, or artificial light. Moreover, the light source 102 may also include a spotlight to focus light on the image projection module 106. In addition, other auxiliary devices such as light condensers and light guide devices can be added to the light source 102 to transmit external backlight into the optical projection module 100.

The image projection module 106 comprises an optic module 120 and a projective lens 122, receiving light for processing some processes such as image reproduction, image display, image size adjustment, and focus such that images are successfully displayed at a desired position. The optic module 120 comprises an optical engine, a lens, and a color wheel (or color selection module). The projective lens 122 comprises lenses (not shown).

The casing 108 contains the light source 102 and the image projection module 106 blocking light from the light source 102. The casing 108 comprises at least one heat-dissipation vent 110 to dissipate heat from the light source 102 and the image projection module 106. Heat-dissipation vents 110 are shown in FIG. 2 as rectangular or polygonal vents 110a, circular vents 110b and 110c, elliptical vents, or other vents with special patterns.

The fan assembly 104 is disposed on the casing 108 blocking light from the light source 102 and dissipating heat therefrom. The fan assembly 104 can be disposed either outside or inside the casing 108. Additionally, the fan assembly 104 can be disposed on both inside and outside of the casing 108.

The fan assembly 104 comprises a plurality of primary blades 114 and a hub 116. The primary blades 114 encircle the hub 116 and adjacent primary blades 114 partially overlap in an axial direction. A region formed by the primary blades 114 and the hub 116 blocks the light transmitting through the heat-dissipation vent 110. The hub 116 comprises a driving circuit, stator, and rotor (not shown). The region formed by the blades 114 and the hub 116, while of varying shapes and sizes, substantially covers the heat-dissipation vent lob. The primary blades 114 are flat, wing-shaped, curved, or sloped. The blades 114 can doubly or multiply overlap. That is, at least two adjacent primary blades 114 are overlapped. Furthermore, the sizes of an inlet blocking face and an outlet blocking face of the primary blades 114 can be the same or different.

The fan assembly 104 and the casing 108 can be connected via a base 118, such that the heat-dissipation vent 110 is blocked by the fan assembly 104. The fan assembly 104 is connected to the base 118, and engaged with a support 124. Conversely, the base 118 can be connected to the support 124 before connecting the fan assembly 104 and the base 118. Moreover, the base 118 and the fan assembly 104 are connected to clamp the support 124. Thus, the fan assembly 104 and the base 118 can be connected by engaging, locking, gluing, integrally formed into a unit, or combination thereof.

Although a single heat-dissipation vent corresponding to a single fan assembly is given here as an example, a plurality of fans may also be disposed corresponding to a single vent as long as the vent is completely blocked thereby.

Furthermore, the optical projection module 100 also comprises at least one guide structure 112 to adjust airflow around the fan assembly 104, increasing heat dissipation. Further, heat dissipation at a localized region in the optical projection module 100 can also be enhanced. The guide structure 112 comprises a curved cross section and encircles the periphery of the heat-dissipation vent 110 on the casing 108 or the periphery of the fan assembly 104 on the casing 108. Additionally, the guide structure 112 comprises at least one guide wall 112a on the periphery of the fan assembly 104 or the heat-dissipation vent 110 with a predetermined gap therebetween. The guide wall 112 may also be a frame 126 encircled an edge of the fan assembly 104. The guide structure 112 and the casing 108 are connected by engaging, locking, gluing, or integrally formed into one unit.

The guide structure 112 can be connected to the fan assembly 104 by a rib, surrounding a periphery of each blade 114. The fan assembly 104 is also connected to the casing 108 by the guide structure 112.

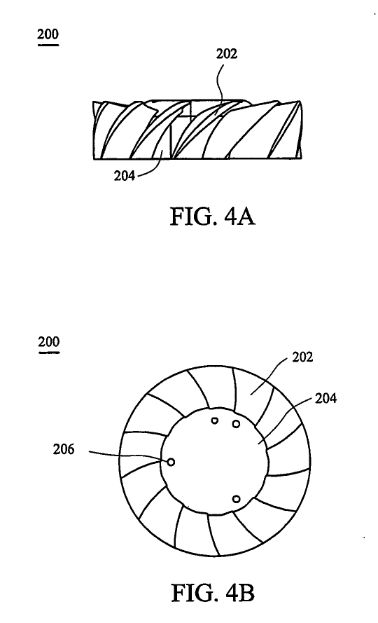

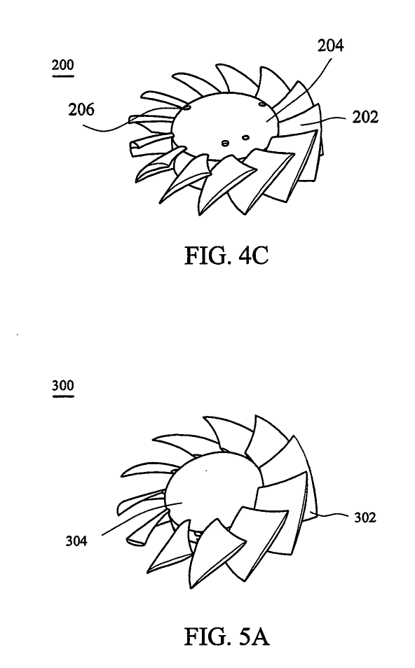

FIG. 4A is a schematic diagram of a fan assembly 200 of a first embodiment of the invention. FIG. 4B is a top view of the fan assembly 200 of FIG. 4A. FIG. 4C is a perspective side view of the fan assembly 200 of FIG. 4A.

In FIGS. 4A to 4C, the fan assembly 200 comprises a hub 204 and a plurality of primary blades 202. The adjacent primary blades 202 partially overlap in an axial direction. As shown in FIG. 4B, the primary blades 202 and the hub 204 form a circular region. Note that the hub 204 and the primary blades 202 are integrally formed as a single unit.

Furthermore, at least one opening 206 can be formed on the hub 204 to expose circuits therein. The opening 206 is blocked by the circuits therein.

The fan assembly for blocking light can be disposed in the front or back of the optical projection module, providing equal heat dissipation.

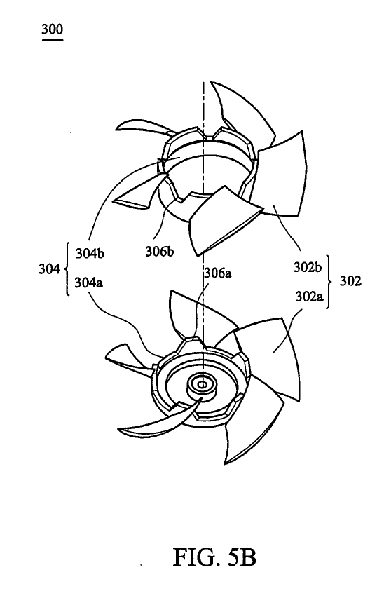

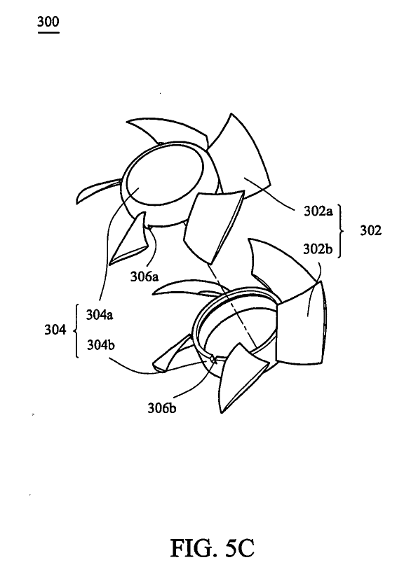

FIG. 5A is a schematic diagram of a fan assembly 300 of a second embodiment of the invention. FIG. 5B is an exploded view of the fan assembly 300 of FIG. 5A. FIG. 5C is an exploded view of a variation of the fan assembly 300 of FIG. 5A. The difference between the second embodiment and the first embodiment is that the fan assembly 300 of the second embodiment comprises two detachable and connectable bodies 304a, 304b combined to form hub 304. Secondary blades 302a and 302b encircle the bodies 304a, 304b with a predetermined gap therebetween, respectively. The secondary blades 302a and 302b can be combined and integrated into a primary blade 302 in an alternative or a collective arrangement. Size and shape of secondary blades 302a, 302b are substantially the same as the primary blades 302.

Furthermore, the bodies 304a and 304b are correspondingly connected via connecting portions 306a, 306b thereof by engaging, gluing, or inserting to form a complete hub 304. The shape of the connecting portions 306a, 306b is shown in FIG. 5B, wherein the corrugated or castled peripheries thereof correspond to each other. That is, the periphery of the connecting portion 306a comprises protrusions corresponding to grooves of the periphery of the connecting portion 306b, and vice versa.

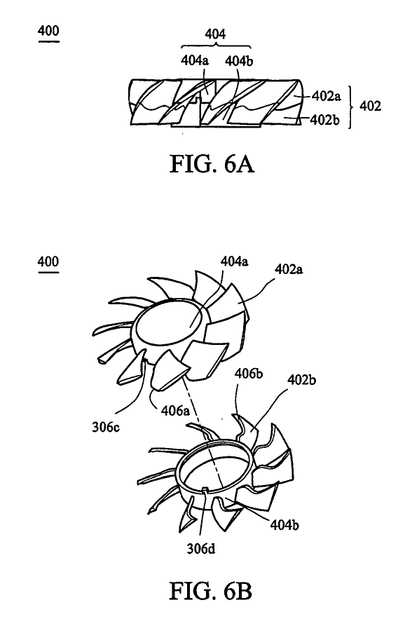

FIG. 6A is a schematic diagram of a fan assembly 400 of a third embodiment of the invention. FIG. 6B is an exploded view of the fan assembly 400 of FIG. 6A. Compared with the second embodiment, as shown in FIGS. 5B, 6A, and 6B, the difference therebetween is that the blades 402a, 402b are located at the bodies 404a, 404b, respectively. When the bodies 404a and 404b are combined to form a complete hub 404, the secondary blades 402a, 402b are correspondingly integrated into one primary blade 402. The connection between the secondary blades 402a, 402b corresponds to the connection between the bodies 404a, 404b, and the connections therebetween can be curved, corrugated, or other shape. Moreover, the ratios of the blades 402a and 402b to the blade 402 can be equal or unequal.

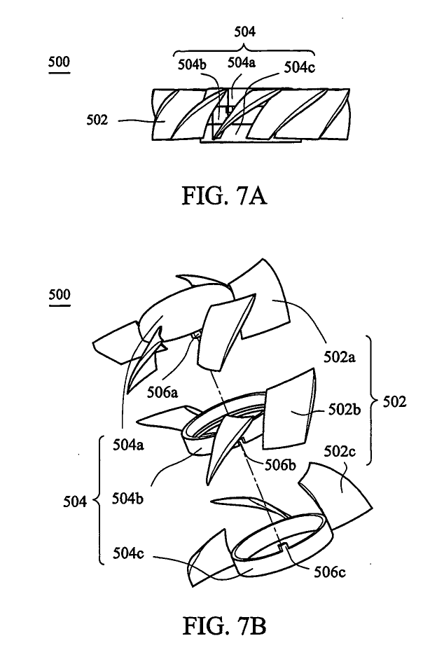

FIG. 7A is a schematic diagram of a fan assembly 500 of a fourth embodiment of the invention. FIG. 7B is an exploded view of the fan assembly 500 of FIG. 7A.

The difference between the fourth and the first embodiments is that the fan assembly 500 comprises three different hubs 504a, 504b, and 504c, integrated into a hub 504. Secondary blades 502a, 502b, 502c encircle the hubs 504a, 504b, and 504c, respectively. When the hubs 504a, 504b, and 504c are connected, the secondary blades 502a, 502b, 502c can be alternatively or correspondingly arranged or overlapped to form a primary blade 502. Each secondary blade 502a, 502b, 502c is shaped as the primary blades 502.

Furthermore, the hubs 504a, 504b, and 504c are mutually connected via connection portions 506a, 506b, 506c by engaging, gluing, and inserting to form a complete hub 504. The connection portions 506a, 506b can be corrugated or other shape.

The invention is not limited to the above embodiments. The blades can be designed with inlet blocking faces greater than outlet blocking faces. The blades can be also designed with outlet blocking faces greater than inlet blocking faces. Moreover, the blocking faces of the blades can be greater than the heat-dissipation vent 110 or equal to the heat-dissipation vent 110.

Moreover, an additional guide board 126 is located at the heat-dissipation vent 110 to guide airflow of the fan to other areas. The guide board can be curved or sloped.

Embodiments of the invention may not require a light blocking structure or board disposed at an inlet or outlet of the vent, since a fan assembly disposed in the front or back of the optical projection module provides sufficient heat dissipation while blocking light. Since airflow at the inlet or outlet of the fan assembly is not affected, during operation, noise level may also be substantially the same whether the fan assembly is disposed in the front or back of the optical projection module such that embodiments of the invention may provide improved heat dissipation and lowered noise level.

While the invention has been described by way of example and in terms of preferred embodiments, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. An optical projection module, comprising:
a casing comprising at least one heat-dissipation vent;
an image projection module, disposed in the casing and providing an image;
a light source providing a light to the image projection module; and
at least one fan, disposed at the heat-dissipation vent of the casing, comprising a hub and a plurality of primary blades encircling the hub, and adjacent primary blades overlapping in an axial direction; wherein a region formed by the primary blades and the hub blocks the light transmitting through the heat-dissipation vent.

2. The optical projection module as claimed in claim 1, wherein the hub comprises a plurality of bodies, each of which includes a periphery and a plurality of secondary blades encircling the periphery such that the secondary blades are combined to form the primary blades.

3. The optical projection module as claimed in claim 2, wherein the secondary blades of each body are correspondingly aligned with each other to form the primary blades.

4. The optical projection module as claimed in claim 2, wherein each secondary blade has a similar shape and dimension as each primary blade, and the secondary blades are alternatively or correspondingly arranged to constitute primary blades.

5. The optical projection module as claimed in claim 1, wherein the primary blades and the hub are integrally formed as a single unit.

6. The optical projection module as claimed in claim 1, wherein the primary blades are flat, wing-shaped, curved, or sloped.

7. The optical projection module as claimed in claim 1, wherein the shape of the region substantially corresponds to the heat-dissipation vent.

8. The optical projection module as claimed in claim 1, further comprising a base, wherein the fan is disposed on the casing via the base.

9. The optical projection module as claimed in claim 1, further comprising at least one guide structure, encircling a periphery of the heat-dissipation vent on the casing, encircling a periphery of the fan on the casing, or surrounding each primary blade.

10. The optical projection module as claimed in claim 9, wherein the guide structure comprises guide walls with a predetermined gap therebetween.

11. The optical projection module as claimed in claim 9, wherein the guide structure comprises a curved cross section.

12. The optical projection module as claimed in claim 1, wherein the hub comprises at least one opening.

13. The optical projection module as claimed in claim 1, further comprising a guide board located at the heat-dissipation vent.

14. A fan assembly for an optical projection module having a casing with at least one heat-dissipation vent, the fan assembly comprising:
a hub; and
a plurality of primary blades, encircling the hub, wherein the adjacent primary blades overlap in an axial direction, and a region formed by the primary blades and the hub blocks a light transmitting through the heat-dissipation vent.

15. The fan assembly as claimed in claim 14, wherein the hub comprises a plurality of bodies, each of which includes a periphery and a plurality of secondary blades encircling the periphery such that the secondary blades are combined to form the primary blades.

16. The fan assembly as claimed in claim 15, wherein the secondary blades of each body are correspondingly aligned with each other to form the primary blades.

17. The fan assembly as claimed in claim 15, wherein each secondary blade has a similar shape and dimension as each primary blade, and the secondary blades are alternatively or correspondingly arranged to constitute primary blades.

18. The fan assembly as claimed in claim 14, wherein the primary blades and the hub are integrally formed as a single unit.

19. The fan assembly as claimed in claim 14, wherein the shape of the region substantially corresponds to the heat-dissipation vent.

20. The fan assembly as claimed in claim 14, further comprising a base, wherein the fan is disposed on the casing via the base.

21. The fan assembly as claimed in claim 14, further comprising at least one guide structure, encircling a periphery of the heat-dissipation vent on the casing, encircling a periphery of the fan on the casing, or surrounding each primary blade.

22. The fan assembly as claimed in claim 21, wherein the guide structure comprises guide walls with a predetermined gap therebetween.

23. The fan assembly as claimed in claim 21, wherein the guide structure comprises a curved cross section.

24. The fan assembly as claimed in claim 14, wherein the hub comprises at least one opening.

25. The fan assembly as claimed in claim 14, further comprising a guide board located at the heat-dissipation vent.
